(19) United States
(12) Patent Application Publication
(10) Pub. No.: US 2011/0286808 A1
(43) Pub. Date: Nov. 24, 2011

(54) INTERNALLY REINFORCED PNEUMATIC CARRIER

(75) Inventor: RAYMOND ANTHONY CASTRO, DENVER, CO (US)

(73) Assignee: TRANSLOGIC CORPORATION, Denver, CO (US)

(21) Appl. No.: 13/077,209

(22) Filed: Mar. 31, 2011

Related U.S. Application Data
(60) Provisional application No. 61/319,372, filed on Mar. 31, 2010.

(51) Int. Cl. B65G 51/04

(52) U.S. Cl. 406/184

(57) ABSTRACT

The presented inventions are directed to a side-opening carrier having an improved rigidity about its centerline axis. In one arrangement, the carrier has mating studs and sockets formed on the interior recessed surfaces of the shells that define the side-opening carrier. These studs and sockets are engaged when the carrier is in a closed position to improve the torsional stability if the carrier, which may prevent the carrier from flexing and/or opening during transport. In another arrangement, internal partitions within the carrier prevent shifting contents from applying outward forces to tapered end potions of the carrier.

### CROSS REFERENCE

This application claims the benefit, under 35 U.S.C. §119(e), of the filing date of U.S. Provisional Application No. 61/319,372 entitled “Internally Reinforced Pneumatic Carrier” having a filing date of Mar. 31, 2010, the entire contents of which is incorporated herein by reference.

### FIELD

The present disclosure relates to carrier vessels for use with pneumatic tube transport systems. More particularly, aspects of the present disclosure relate to a side-opening carrier vessel having internal supports that increase the rigidity of the carrier.

### BACKGROUND

Many buildings or structures include pneumatic tube transport systems for transporting objects, such as products, components, documents, drawings or other materials from one location in the building to another. Pneumatic tube transport systems typically comprise a number of substantially hermetically sealed tubes extending between locations in a building and a mechanism for selectively evacuating air from, or forcing air into, the tubes. In use, objects are placed in a carrier vessel, typically a substantially cylindrical housing, which is placed into the pneumatic tube transport system. The vessel is then propelled through the tube by creating a zone of relatively higher pressure on one side of the carrier vessel than on the other. This may be accomplished by creating a zone of negative pressure (e.g. a vacuum) in front of the vessel or by creating a zone of positive pressure behind the vessel.

In general, such pneumatic tube transport systems include a closed continuous passageway having a predetermined inner cross-sectional dimension where the passageway includes a plurality of curves or bends having a predetermined radius. In order for a carrier to move freely through the passageway, the dimensions, and in particular the length, of the carriers being used have been limited by the inner cross-sectional dimension and curvature radius of the passageway.

Pneumatic carriers for use in such delivery systems come in a wide range of sizes and shapes to accommodate the physical articles to be transported in the system. For example, many such carriers include an end cap that is hinged with respect to a cylindrical body on one side of the hull. In such end-opening carriers, objects are inserted and retrieved through the end of the cylindrical body. Other types of pneumatic tube carriers are of the side-opening variety. One such side-opening carrier employs two generally semi-cylindrical halves (e.g., shells) hinged connected along one longitudinal edge. The hinged shells may be swung toward or away from each other to effectuate opening and closing of the carrier body. Various different latching mechanisms are utilized to maintain the shells in the closed position.

While both end-opening and side-opening carriers are effective for transporting materials in a pneumatic tube transport system, large pneumatic tube transport systems, such as hospitals, more commonly utilize side-opening carriers. One reason for side-opening carrier preference is that these carriers more readily facilitate the loading and unloading of objects/cargo therein.

### SUMMARY

The present inventors have recognized that while side-opening carriers are often preferred by users, these carriers have certain drawbacks. For instance, the split shell design necessarily results in a carrier that has limited rigidity about its centerline axis. That is, such carriers may have reduced torsional stability, which may permit the carrier to flex and/or open during transport.

Accordingly, provided herein are various side-opening carrier arrangements that provide a side-opening carrier having improved rigidity and/or resistance to accidental opening. Such various aspects of the presented inventions are considered novel alone and/or in various combinations.

To accomplish the aforementioned and other objectives, one aspect of the presented inventions provides a carrier that employs mating studs and sockets fowled on facing recessed surfaces of the carrier shells to improve rigidity of the carrier. The carrier includes first and second semi-cylindrical shell members, each having an inside recessed surface and an engagement surface/periphery. Lateral edges of the shells are hingedly connected to allow the shells to move between an open configuration and a closed configuration. When the first and second shell members are in the closed configuration, the engagement peripheries of the shells are juxtaposed and the recessed surfaces of the first and second semi-cylindrical shells define an interior cargo area of carrier. A latch selectively maintains the carriers in the closed position. Interconnected to the inside surface of at least one of the shells is a stud or pin. A mating socket is interconnected to the inside surface of the other shell. When the first and second shells are closed, the socket receives the stud.

In one arrangement, the carrier includes at least two sets of mating studs and sockets. In such an arrangement, a first stud/socket set may be disposed proximate to a first end of the carrier and a second stud socket set may be disposed proximate to a second end of the carrier. By placing the stud/socket sets proximate to each end, the torsional rigidity of the carrier is greatly increased. Further, when closed the mating stud and socket form a pillar that extends across the interior of the carrier. This pillar prevents shifting items within the cargo area of the carrier for contacting the internal ends of the carrier, which can force the shells apart.

Another aspect of the presented inventions provides a side-opening single-stage to close carrier having improved torsional rigidity. In this aspect, the act of closing the carrier effectively latches the first and second shell members in the closed configuration. That is, no secondary user operation is required to effectuate the latching of the carrier shells after initial closure. The carrier includes a first shell having a first engagement surface and a second shell having a second engagement surface. A hinge member interconnects the first and second shells to permit movement between a closed position and an open position. Mating studs and sockets are disposed on the recessed surfaces of the first and second shells. A latch interconnects the first and second shells. The latch includes a biased pawl member that is attached to one of the first and second shells and a detent formed in the other of the first and second shells. The detent receives the pawl as the shells move from the open position to the closed position. Upon the detent receiving the pawl, the carrier is closed and latched free of further user interaction.

The latch may be any mechanism that allows for attaching the first and second shells in conjunction with movement from a first position to a second position where no secondary user engagement is required. In one arrangement, the biased pawl member includes a sliding element and a spring. In this arrangement, the sliding element may compress the spring as the sliding element retracts from the first position to the second position. For instance, a tip of the sliding element may engage a ramped surface (or other angled surface) associated with the detent. That is, the sliding element may automatically retract until it reaches the top of such a ramped surface at which time it may be biased into the detent by the spring.

According to another aspect of the invention, a carrier having tapered ends to facilitate passage through a pneumatic tube system is provided that is resistant to accidental opening. The carrier includes first and second recessed shell members having mating engagement surfaces that, when disposed in a closed position, define an enclosed carrier. The carrier has first and second tapered ends and a central portion there between. Likewise, each recessed shell includes tapered end portions and a central portion there between. In addition, formed on the inside recessed surfaces of the shell members are a set of partitions. These partitions are disposed proximate to the interfaces of the tapered end portions and the central portion of the carrier. When the shells are in the closed position, each partition is juxtaposed proximate to a mating partition in the other shell. Collectively these juxtaposed partitions form a barrier that at least partially isolates the central interior portion of the enclosed carrier from the tapered end portions. Accordingly, transferred items (e.g., IV bags etc) cannot move to the end portion where they may potentially apply an outward force on the tapered end portions of the carrier shells. The partitions may be formed as continuous barriers (e.g., walls). In other arrangements, the partitions may be formed of mating studs and sockets that form, for example, one or more pillars when the shells are in the closed position.

Additional advantages of the present invention will become readily apparent from the following discussion, particularly when taken together with the accompanying drawings.

### BRIEF DESCRIPTION OF THE DRAWINGS

FIG. 1 is a perspective view of one embodiment of a carrier vessel when closed;

FIG. 2 illustrates one embodiment of a carrier vessel when opened;

FIG. 3 is a cross-sectional view of one embodiment of internal studs of the carrier.

FIGS. 4A-4C illustrate one, non-limiting, embodiment of a single-stage latch.

### DETAILED DESCRIPTION

Reference will now be made to the accompanying drawings, which assist in illustrating the various pertinent features of the present disclosure. In this regard, the following description is presented for purposes of illustration and description.

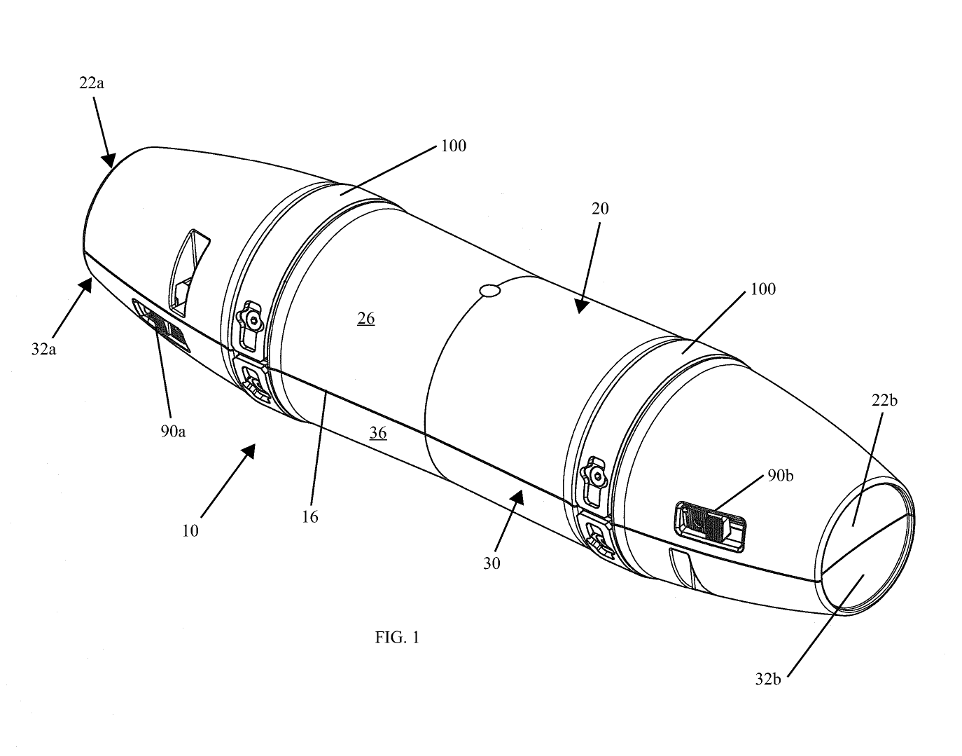

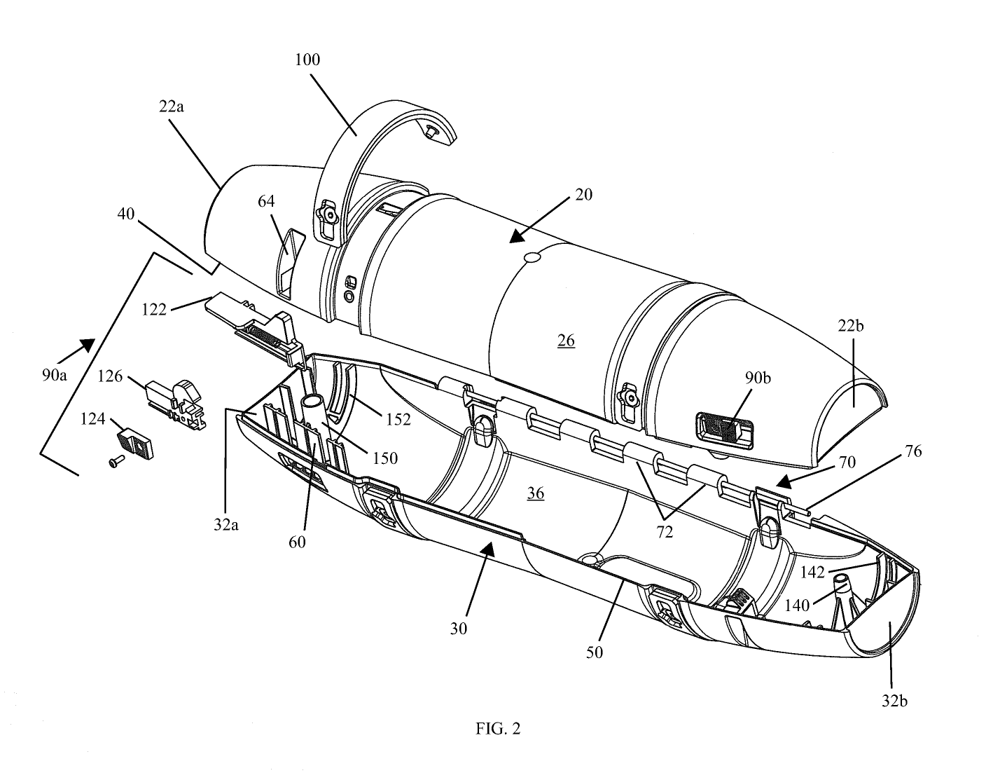

FIGS. 1, and 2 illustrate one embodiment of a carrier 10, which may be used to house objects being transported in a pneumatic tube transport system. The carrier 10 includes a first shell member 20 and a second shell member 30 engageable along opposing engagement surfaces that at least partially define an interface 16 when the shell members are engaged and form a substantially cylindrical carrier vessel having a generally hollow interior area or cargo area.

The first shell member 20 includes first and second end walls 22a, 22b. A semi-cylindrical housing wall 26 extends between the first and second end walls 22a, 22b. The edges of the end walls 22a, 22b and housing wall 26 define a first engagement surface 40, which extends substantially in a single plane about the perimeter of the first shell member 20. Second shell member 30 is similar in shape to the first shell member 20 and includes first and second end walls 32a, 32b and a semi-cylindrical housing wall 36. Being semi-cylindrical, the housing walls 26, 36 define a recessed inside surface and a convex outside surface. As more fully discussed herein, mating pins/studs 140 and sockets 150 are disposed on the inside surfaces of the first and second shells 20, 30 for mating engagement when the shells close.

The edges of the end walls 32a, 32b and housing wall 36 of the second shell member 30 define a second engagement surface 50 Which extends substantially in a single plane about the perimeter of the second shell member 30. Shell members 20, 30 are in one embodiment formed from a translucent, rigid plastic material, however it will be appreciated that numerous other materials, including opaque materials, metals or carbon composite materials, could be used. In the present embodiment, first and second ends of the carrier are tapered or frustoconical. Such tapered ends facilitate movement of the carrier through bends in a pneumatic tube system. However, it will be appreciated that other embodiments may utilize different configurations. For instance, the shells need not collectively define a round cylinder and may have any enclosed shaped (e.g., oval, rectangular etc.).

When the first and second engagement surfaces 40, 50 are juxtaposed (i.e., the carrier is closed) the carrier defines a generally cylindrical vessel having an enclosed interior. Further, these engagement surfaces 40, 50 may also include a sealing element that allows the carrier to be fluid tight (e.g., leak resistant) when the carrier is closed. One non-limiting exemplary seal arrangement for a carrier is provided in co-pending U.S. patent application Ser. No. 12/774,366 entitled: “Sealed Pneumatic Carrier with Slam Latch” and having a filing date of May 5, 2010, the entire contents of which is incorporated by reference herein. A hinge assembly 70 joins the first and second shell members 20, 30 together to permit pivotal movement there between. The hinge assembly 70 includes first and second sets of ferrules 72 (only one shown) that are attached along a lateral edge of the first and second shells 20, 30. Each set of ferrules are spaces longitudinally along their respective housing wall 26 or 36 for alternating engagement with the ferrules on the opposing shell. In the present embodiment, these ferrules are an integral part of the shell members 20, 30. It will be appreciated that more ferrules could be used or that such ferrules could be formed separately and secured to shell members 20, 30 using conventional fasteners. A hinge pin 76 is disposed through the inside of the ferrules 72 to ensure that the shell members 20, 30 are aligned and allow movement between an open position and a closed position. The carrier 10 also includes wear bands 100 for positioning the carrier within tubes of the pneumatic tube system and for creating a seal across the carrier when positioned within such tubes. As illustrated in FIG. 1 identical first and second sets of wear bands are attached to the first shell member 20 and the second shell member 30.

The shells 20, 30 do not necessarily form perfectly flat and level engagement surfaces. Generally, being constructed of plastic materials, the shells are subject to manufacturing tolerances and variations. That is, the shells are not perfectly symmetric and can be slightly warped. In addition, the latches and hinges that close the first and second shells, 20, and 30 are usually positioned irregularly around the perimeter of the carrier. The result is the carrier body needs to be stiff enough to provide sufficient beam stiffness in areas remote from the latches and the hinge to maintain closure during transport. Generally, thicker carrier shells provide better rigidity. However, the thickness of the shells must be balanced with the weight of the carrier.

One problem associated with prior carriers, and especially side-opening carriers, is the ability for the carrier to twist during transport. That is, side-opening carriers having an interface that bisects the carrier are susceptible to bending and twisting forces about this interface. Such bending and twisting between the separate carrier shells 20, 30 can result in the shells spreading during transport and/or one or both of the latches becoming undone. One particularly common problem is cross-latching. In such an arrangement, forces applied to the carrier permit enough twisting that one latch 90 becomes unconnected. In this situation, one end of the carrier is slightly open. In such an arrangement, the cross-latched carrier may become stuck within the system and/or contents of the carrier may spill into the system.

Accordingly, to provide improved structural rigidity and especially rigidity in relation to twisting forces without utilizing excessively thick carrier shells, the present carrier 10 utilizes internal reinforcements. Specifically, the first and second shells include an internal stud 140 and an internal socket 150. As best illustrated in FIG. 2, each shell 20 or 30 incorporates a stud 140 disposed proximate to one end and a socket 150 disposed proximate to the other end. However, it will be appreciated that either shell may incorporate only studs or sockets. In the present, utilization of a stud and socket in each shell allows making the shells in a common mold. However, this is not a requirement. Generally, the studs and sockets are integrally formed with the sidewall of the carrier shells during the injection molding process that forms the shells. As shown, each stud or socket 140, 150 may incorporate various support ribs 142, 152 and flanges 144, 154.

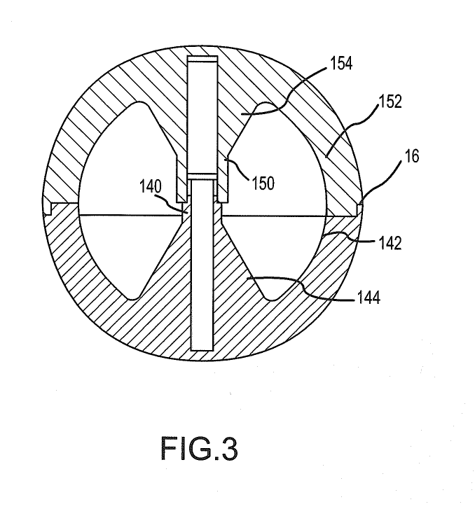

FIG. 3 illustrates a cross-sectional view of the carrier 10 incorporating the studs and sockets. The cross-sectional view extends through the stud and socket while the first and second shells are in the closed position. As shown, the stud 140 and socket 150 are interconnected to the bottom of each of the recessed surfaces of the first and second shells 20, 30, respectively. In the present embodiment, the stud and socket 140, 150 are interconnected along the centerline axes of the recessed surfaces. Distal ends of one or both of these elements 140, 150 extend above the central reference plane of the closed carrier as defined by the interface 16. In this regard, as the shells move from an open position to a closed position, the distal tip of the stud 140 is received into the hollow end of the socket 150. Preferably, enough of the stud 140 is received within the socket 150 to provide structural engagement thereof. That is, it may be desirable that the pin/stud 140 will form a friction fit within the socket 150 such that these elements transfer forces there between when the carrier is closed.

Also illustrated in FIG. 3 are various ribs 142, 152 and flanges 144, 154 that may be variously attached to and/or formed with the pins and studs to provide enhanced reinforcement thereof. That is, in some arrangements attachment limited to the base of the stud or socket and the carrier shell may not provide a desired level of rigidity for these elements. Accordingly, one or more sets of ribs 142, 152 may connect to the stud/socket and extend about the inside surface of the shell to provide increased connection area between the stud/socket and the carrier shell. Further, the one or more flanges 144, 154 may extend from the rib toward the distal end of the stud/socket to provide additional lateral support. As illustrated in FIG. 3, when the first and second shells 20, 30 are closed, the stud and socket collectively define a pillar that extends across the inside surface of the carrier 10. In addition to resisting torsional forces applied to the carrier, these pillars also help the carrier to resist bending forces applied along the central/long axis of the carrier. Furthermore, this pillar prevents cargo within the interior of the carrier from contacting the ends of the carrier during transport. That is, the pillar forms a partition that isolates carrier contents from the carrier ends. It will be appreciated that during transport, carriers are often subjected to high G forces as the carriers come to a stop and/or are started in transit. In such an arrangement, loosely contained objects within the cargo area may slide to one end of the carrier. In carriers that utilize the frustoconical/tapered ends as illustrated in FIGS. 1 and 2, the sliding of objects within the cargo area can have the effect of applying outward forces to the inside surfaces of these tapered ends, which works to force the shells apart and can result in one of the latches becoming unlatched (e.g., a cross-latch situation). By providing a vertical pillar or other partition that extends between the first and second shells, such shifting objects are prevented from hitting the inside tapered end portions of the carrier and thus are less likely to provide a separating force on the carrier. That is, as such shifting objects hit the vertical pillar, most or all of the force of the shifting object may be redirected along the long axis of the carrier rather than as an outward force.

While illustrated herein as utilizing a stud and socket to form a pillar across the interior of the carrier, it will be appreciated that in other arrangements interior partitions may provide reinforcement and/or isolation of the tapered ends. For instance, interior walls formed on the recessed surfaces of the first and second shells may mate or abut when the shells are closed to isolate an interior central portion of the carrier from the tapered ends of the carrier. That is, partitions formed in the inside recessed surfaces of the shells may define a barrier between the central portion and the tapered end portions of the carrier to prevent undesired shifting of contents to the end portions of the carrier.

The latching or connecting mechanisms for releaseably holding the shell members 20, 30, together are next described in more detail. FIGS. 1, 2 and 4A-4C illustrate one non-limiting embodiment of a latching mechanism. As illustrated, these latching or connecting mechanisms comprise a pair of latch assemblies 90a, 90b that releasably attach the first and second shell member in the closed position. Each of the latch assemblies 90a, 90b (hereafter 90) includes a latch pawl 126 having a hooked tip. The latch assemblies also have an internal bias force member (e.g., spring coil, leaf spring, etc.) that permits linear movement of the pawl member 126 between a first position and a second position (e.g., an extended position and a retracted position). The latch pawl 126 and bias force member are connected to one of the shell members such that the hooked tip may engage a detent on the other shell.

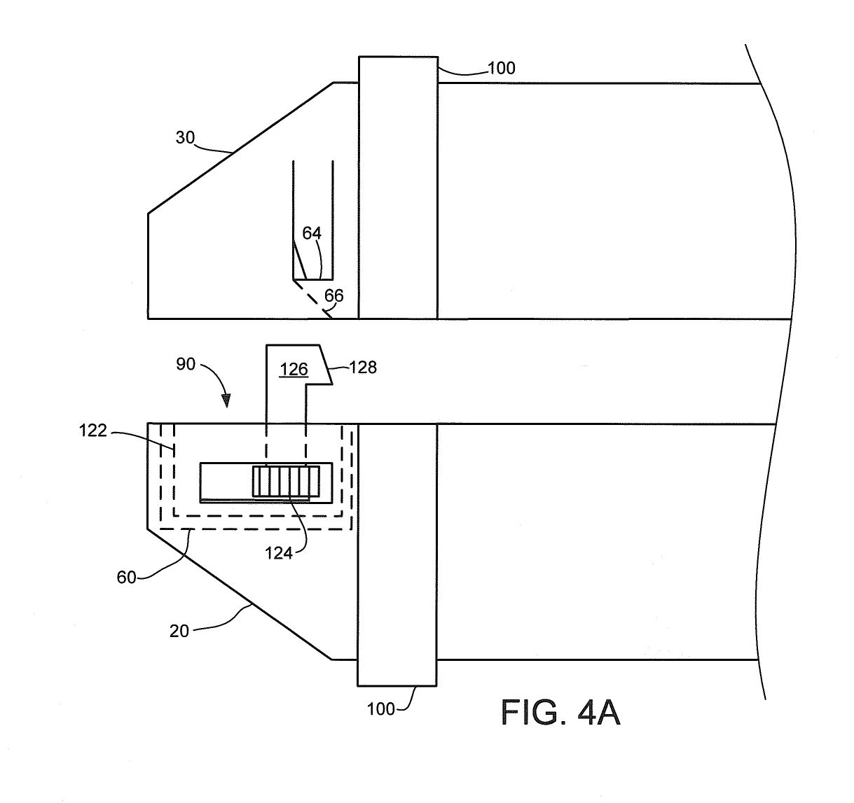

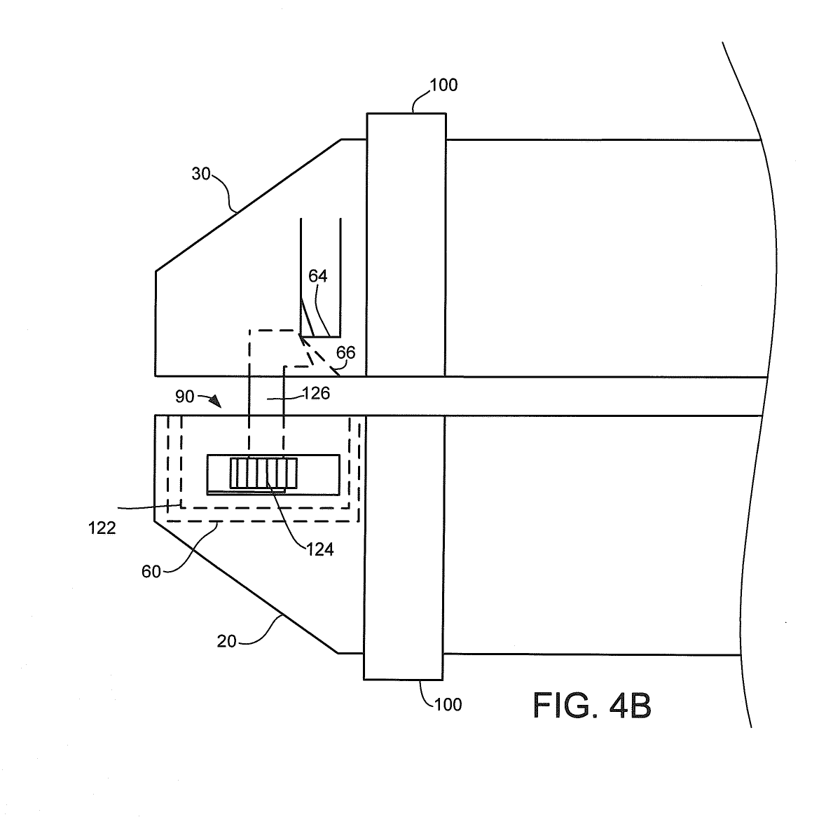

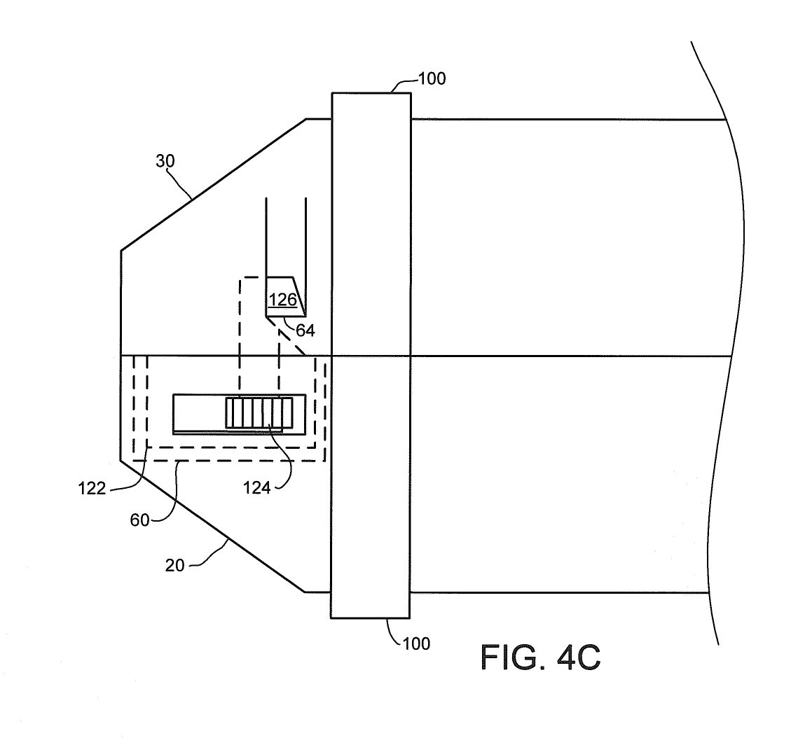

As better illustrated in FIGS. 2 and 4A-4C, the latch assemblies 90 are disposed within a receiving recess or pocket 60 formed in the front corner of the shell members 20, 30. Each latch assembly 90 includes a base member 122 that is disposed within the pocket 60 formed in the respective shell member. This base member 122 supports the latch pawl 126 as well as the bias force member. Once inserted within the pocket 60, a latch handle 124 is interconnected to the pawl 126. More specifically, the latch handle is disposed through an aperture formed in the housing wall 26. In the present embodiment, the latch handle may be secured to the pawl 126 utilizing a screw or other fastening means. Once so interconnected, the latch handle prevents the latch mechanism 90 from being removed from the pocket 60 within the shell member. As illustrated in FIGS. 4A-4C, the aperture through the sidewall is elongated, which allows the latch handle to move forward and backward between an extended position (e.g., FIG. 4A) and retracted position (e.g., FIG. 4B). Likewise, movement of the latch handle allows for compressing the bias force member, thereby retracting the pawl 126. The other shell member includes a detent 64 that is adapted to receive the hooked end of the pawl 126. Specifically, as shown in FIG. 4A, a top surface 128 of the pawl 126 is slanted and is adapted to engage a ramped surface 66 within the shell member 30 including the detent 66. When the first and second shell members are closed, the pawl is disposed in a pocket in opposing shell and the slanted top surface of the pawl 126 engages the ramped surface 66 of the detent 64, thereby compressing the bias force member and allowing the pawl 126 to automatically retract (See FIG. 4B). When the first and second shells are closed (See FIG. 4C), the hooked end of the pawl 126 falls over the top edge of the ramp 66 into the detent 64. This secures the first and second shells in the closed position. Accordingly, a user may open the shells by grasping the latch handles (e.g., with both thumbs on the first and second latching assemblies 90a, 90b) and retracting the pawls from the detents

Importantly, the relationship between the pawl 126 and the detent 64 is such that when the pawl 126 is engaged with the detent during closing, the carrier is effectively closed and no further user operation is required to latch the carrier. That is, the latch assembly 132 is a single stage latch where simply closing the shell members engages the latch. The foregoing description of the present invention has been presented for purposes of illustration and description. Furthermore, the description is not intended to limit the inventions to the forms disclosed herein. Consequently, variations and modifications commensurate with the above teachings, and within the skill and knowledge of the relevant art, are part of the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

1. A pneumatic carrier for use in a pneumatic tube transport system, comprising:
first and second shells having first and second recessed surfaces and first and second engagement surfaces, respectively, wherein the first and second engagement surfaces mate in a closed position to define an enclosed space;
a hinge member coupled to the first and second shells and permitting movement between the closed position and an open position;
a latch having a first portion attached to one of the first and second shells, wherein the latch is operative to engage the other of the first and second shells to secure the shells in the closed position;
a first stud interconnected to the recessed surface of one of the first and second shells;
a first socket interconnected to the recessed surface of the other of the first and second shells, wherein a distal end of the first stud is received within a hollow interior of the first socket when the first and second shells are in the closed position.

2. The apparatus of claim 1, wherein the first stud and first socket are integrally formed with their respective shell.

3. The apparatus of claim 1, wherein the bases of the first stud and first socket are disposed on centerlines of their recessed shell member.

4. The apparatus of claim 3, wherein the first and second engagement surfaces define first and second reference planes, and wherein the distal ends of at least one of the first stud and the first socket extend from the base and beyond its respective reference plane.

5. The apparatus of claim 1, further comprising:
a second stud interconnected to the recessed surface of one of the first and second shells;
a second socket interconnected to the recessed surface of the other of the first and second shells, wherein a distal end of the second stud is received within a hollow interior of the second socket when the first and second shells are in the closed position.

6. The apparatus of claim 5, wherein the first stud and socket are disposed proximate to a first end of the carrier and the second stud and socket are disposed proximate to a second end of the carrier.

7. The apparatus of claim 1, further comprising:
a seal element that is disposed between the first and second engagement surfaces in the closed position.

8. The apparatus of claim 7, wherein the hinge member and the latch are disposed outside of the peripheries of the engagement surfaces.

9. A pneumatic carrier for use in a pneumatic tube transport system, comprising:
first and second shells having first and second recessed surfaces and first and second engagement surfaces, respectively, wherein the first and second engagement surfaces mate in a closed position to define an enclosed carrier having first and second tapered end potions and a central portion between the tapered end portions;
a hinge coupled to the first and second shells and permitting movement between the closed position and an open position;
a latch having a first portion attached to one of the first and second shells, wherein the latch is operative to engage the other of the first and second shells to secure the shells in the closed position;
a first set of partitions disposed in the recessed surface of the first shell proximate to an interface between a central portion of the first shell and first and second tapered end portions of the first shell;
a second set of partitions disposed in the recessed surface of the second shell proximate to an interface between a central portion of the second shell and first and second tapered end portions of the second shell;
wherein the first and second sets of partitions are juxtaposed when the first and second shells are disposed in the closed position, wherein the juxtaposed sets of partitions at least partially define a barrier between an inside volume of the central portion of the enclosed carrier and inside volumes of the first and second tapered end potions of the enclosed carrier.

10. The carrier of claim 9, wherein a top surface of each the first set of partitions abuts a top surface a corresponding one of the second set of partitions when the first and second shells are in the closed position.

11. The carrier of claim 10, wherein a projecting element of at least one of the first set of partitions is received within a recess formed in a corresponding one of the second set of partitions.

12. The carrier of claim 10, wherein the partitions comprise an internal walls that extend from the recessed surface of their respective shell proximate to a reference plane defined by the engagement surface of their respective shell.

13. The carrier of claim 9, wherein the first and second sets of partitions each comprise at least one of:
a stud interconnected to the recessed surface; and
a socket interconnected to the recessed surface having a hollow interior for receiving a distal end of a stud.

14. The carrier of claim 13, wherein each set of partitions include one stud and one socket.

15. The carrier of claim 13, wherein the first and second engagement surfaces define first and second reference planes, and wherein the distal ends of at least one of the stud and first socket extend from the recessed surface of its respective shell member beyond its respective reference plane.

16. The carrier of claim 9, wherein the first and second sets of partitions are integrally formed with the first and second shells, respectively.

17. The carrier of claim 9, further comprising:
a seal element that is disposed between at least a portion of the first and second engagement surfaces in the closed position.

18. The carrier of claim 17, wherein the seal is disposed between at least a portion of the partitions when the shells are in the closed position.

19. The carrier of claim 9, wherein the hinge member and the latch are disposed outside of the peripheries of the engagement surfaces.

20. A method for use with a pneumatic carrier for use in a pneumatic tube transport system, comprising:
rotating first and second recessed shells from an open positions to a closed position to define an enclosed carrier having an interior volume;
in conjunction with rotating, disposing a distal end portion of a stud interconnected to an inside recessed surface of one of the first and second shells into socket interconnected to an inside recessed surface of the other of the first and second shells; and
engaging at least a first latch to maintain the first and second shells in the closed position.
